(19) United States
(12) Patent Application Publication
(10) Pub. No.: US 2026/0356494 A1
(43) Pub. Date: Nov. 12, 2026

(54) BAGGAGE SORTING FACILITY FOR AN AIRPORT FOR AUTOMATICALLY PRESORTING AND FEEDING BAGGAGE ITEMS

(71) Applicant: AAT AUTOMATION GMBH, Karlsruhe (DE)

(72) Inventors: Daniel KAISER, Kalsruhe (DE); Roman KAISER, Kalsruhe (DE)

(73) Assignee: AAT AUTOMATION GMBH, Karlsruhe (DE)

(21) Appl. No.: 19/470,137

(22) PCT Filed: Sep. 25, 2023
(86) PCT No.: PCT/EP2023/076398

§ 371 Date: Sep. 29, 2025

(30) Foreign Application Priority Data
Mar. 29, 2023 (DE) 10 2023 107 924.7

(51) Int. Cl. B64F 1/36; B07C 5/10; B07C 5/36

(52) U.S. Cl. CPC B64F 1/368; B07C 5/10; B07C 5/361; B07C 2501/0063

(57) ABSTRACT

A baggage sorting facility for an airport for automatically presorting and for transferring the baggage items from a conveyor belt to a feeder belt for feeding to a loading station comprises a transfer unit for transferring baggage items from the conveyor belt to the feeder belt; a baggage detection unit for detecting baggage items and for categorizing individual baggage items; and a control unit for selecting individual baggage items for transfer to the feeder belt based on the categorization and/or on predefined requirements for loading into the freight container. The transfer unit includes a baggage item handler, which is designed and set up to transfer a baggage item from the conveyor belt to the feeder belt. During the transfer by means of the transfer unit, an automatic presorting of the baggage items takes place.

The present invention relates to a baggage sorting facility for an airport for automatically presorting and removing baggage items from a conveyor belt and transferring the baggage items to a feeder belt adjacent to the conveyor belt for feeding to a loading station for loading a freight container. The invention further relates to a system comprising the baggage sorting facility, a conveyor belt for transporting baggage items and a feeder belt for feeding baggage items to a loading station.

An automated conveying and sorting of baggage items has already been taking place for some time at airports, in particular at larger airports. The systems used for this purpose serve to transport baggage items from various entry points, for example from a drop-off point in the check-in area, to a loading station in a targeted manner. The baggage items can here be correspondingly presorted by flight number and flight class. At the loading station, the baggage items are most often manually loaded from a conveyor belt or feeder belt into suitable containers such as transport containers for transport to the aircraft.

The baggage items are transported within the conveying systems by technical equipment, such as belt conveyors or tray transport systems with an endless belt, in which transport trays are endlessly joined together. Suitable vehicles or airplanes are also used to transport and convey baggage items or containers.

As a rule, the containers are loaded by people, either manually or by hand. The airport employees remove the baggage item from the belt conveyor and place or stack it in the corresponding freight container, which is then driven to the aircraft for which the baggage item is provided. The freight containers are filled and placed depending on the baggage items to be loaded, and on their size, weight and shape. The arrangement and potentially sorting depend on the skill of the individual employees. It is here possible to manually change the sequence in which the baggage items are delivered to the loading station by having the employee walk along the feeder belt and select a suitable baggage item, so as to optimize loading and the fill level of the freight container.

During automated loading, the baggage items are removed from the feeder belt in the order in which they arrive at the end of the feeder belt. Presorting cannot take place with existing systems, in particular additional reconstruction measures are undertaken and the existing space is to be used for loading and feeding purposes.

As a consequence, there is a need to create an improved feeding of baggage items to a loading station for automatic unloading purposes.

The present object is achieved by a baggage sorting facility with the features of claim 1, by a system with the features of claim 13, by a control unit with the features of claim 16, as well as by a method with the features of claim 18.

In a first aspect, the present invention relates to a baggage sorting system for an airport for realizing an automatic presorting and a removal of baggage items from a conveyor belt. The baggage sorting facility transfers baggage items from the conveyor belt to an adjacent feeder belt, which is provided to feed the baggage items to a loading station, at which the baggage items are loaded into a freight container.

The baggage items are preferably loaded at the loading station automatically, for example with an automatic placement system.

The baggage sorting facility here comprises a transfer unit with a baggage item handler, with which baggage items can be transferred from the conveyor belt to the feeder belt. The baggage items are transferred by means of the transfer unit, preferably essentially perpendicular to the conveyor belt and/or the feeder belt. A baggage item can here be transferred from the conveyor belt to the transfer unit, preferably in a first step, and from the transfer unit to the feeder belt in a second step, so as to then be moved further in the direction of a loading station. The baggage items are moved by means of the baggage item handler, which can have various design configurations, and realizes an automatic movement of the baggage items.

Transferring a baggage item from the conveyor belt in the direction of the feeder belt with the transfer unit requires baggage detection, which is performed by means of a baggage detection unit. The baggage detection unit categorizes the individual baggage items, for example by type, size or condition. Of course, various subunits can be used within the baggage detection unit to detect the baggage items and categorize the individual baggage items. These subunits can also be spaced apart from each other. For example, it is conceivable for categorization to take place directly at an entry point, e.g., the drop-off point in the check-in area. Information about the category or type of baggage item can be stored directly in the baggage detection unit, or also transported with the baggage item itself, for example, e.g., in the form of a banderole, a QR code or an RFID, which is directly arranged on the baggage during baggage check-in.

A control unit of the baggage sorting facility controls the transfer unit, and selects individual baggage items for transfer to the feeder belt. Selection takes place based on the detected baggage items and based on the categorization. Furthermore, the selection can additionally or alternatively be made based on predefined requirements for a loading into the freight container. For example, it is conceivable that the control unit recognize that large baggage items are to be selected first, and smaller baggage items, such as smaller suitcases or beauty cases, only thereafter. It is also possible for the control unit to continue processing the dimensions of the detected baggage items and compare the respective dimensions of the baggage with the surface or volume information inside of the freight container, and thereupon decide about the selection of baggage items. Information about the current fill level and placement configuration of a freight container can be made available to the control unit by a placement system.

An automatic presorting of baggage items during the transfer takes place by selecting the baggage items based on the requirements or the categorization, or also based on the dimensions of the baggage items. In this way, for example, individual baggage items can be transferred from the transfer unit to the feeder belt, while other baggage items are transported past the transfer unit without a transfer taking place. This can be provided in particular if the conveyor belt for delivering the baggage items is designed as a carousel, so that baggage items that have passed by the transfer unit without a transfer arrive at the latter once again at a later point in time.

Another aspect of the invention relates to a baggage sorting system for an airport for automatically presorting and removing baggage items from a conveyor belt. The baggage sorting system is designed to transfer baggage items from the conveyor belt to a feeder belt, wherein the feeder belt is preferably adjacent to the conveyor belt. The feeder belt feeds the baggage items to a loading station, in which the baggage items are loaded or placed onto a freight container.

The baggage sorting system according to the invention comprises the baggage sorting facility as described above, the conveyor belt, by means of which baggage items are transported from a drop-off point in the direction toward a loading point at the airport, and the feeder belt, so as to transport the baggage items to the loading station. The loading station is here arranged at the end of the feeder belt, but preferably not part of the baggage sorting system. Alternatively, the loading station can be allocated to the sorting system. The conveyor belt and feeder belt are arranged in such a way that the baggage sorting facility is located at least partially between the conveyor belt and the adjacent feeder belt. As a rule, use is here made of the space available at an airport, so that the baggage sorting facility can be installed without any changes to the structure of baggage handling within the airport.

Another aspect of the present invention relates to a control unit for selecting individual baggage items to be transferred from a conveyor belt to the feeder belt, wherein the selection is based on a categorization of the baggage items and/or on other predefined requirements for loading in the freight container. The control unit comprises an input interface, so as to receive information from a baggage detection system or unit, for example a baggage sorting facility. The information relates to baggage items on the conveyor belt, wherein the information can a involve categorization of the baggage items. The control unit further comprises an output interface for outputting a control signal for a transfer unit or a baggage item handler of a transfer unit. For this purpose, the control unit is designed to generate the control signal, by means of which the transfer unit is controlled in such a way as to transfer baggage items from the transport belt to the transfer unit.

The control unit is configured in such a way that a detected baggage item can be selected based on the information of the baggage detection unit. Alternatively or additionally, selecting a detected baggage item can also be based on a performed categorization. The control signal generated by the control unit is used to control the transfer unit or the baggage item handler in such a way that the selected baggage item is transferred from the conveyor belt to the transfer unit.

The control unit can preferably further be designed to generate an additional or expanded control signal, with which the transfer unit is actuated so as to transfer the selected baggage item from the transfer unit to the feeder belt. It is also possible for the control signal to be designed in such a way that a direct transfer of a baggage item from the conveyor belt to the feeder belt takes place by means of the transfer unit. The control signals are here adjusted and adapted to the used transfer unit and its embodiment. Corresponding control signals are generated and output depending on the characteristics of the transfer unit.

Additional aspects relate to a corresponding method for automatically presorting and removing baggage items and transferring the baggage items to a feeder belt. For example, the method can be realized in the form of a computer program product with a program code for executing the steps of the method, wherein the procedural steps are performed when the program code is executed on a computer.

Preferred embodiments of the invention are described in the dependent claims. It goes without saying that the features mentioned above and yet to be described below can be used not just in the respectively indicated combination, but rather in other combinations or alone as well, without departing from the framework of the present invention. In particular, the method and the computer program product can be designed according to the embodiments described in the dependent claims for the device.

According to the invention, baggage items are transferred from the conveyor belt to the feeder belt by means of the transfer unit. This transfer unit can have different kinds of designs. As a rule, it comprises a baggage item handler to transfer the baggage items from the conveyor belt to the feeder belt. For example, this can be done directly or indirectly, in one or several steps.

In a preferred embodiment of the baggage sorting facility, the transfer unit has a temporary storage, which is designed to hold a baggage item. In this embodiment, then, a baggage item is as a rule indirectly transferred from the conveyor belt to the feeder belt. A transfer from the conveyor belt into the temporary storage is here initially carried out. In an additional step that can follow directly or be time delayed, the baggage item is then transferred from the temporary storage to the feeder belt. As a rule, the baggage item remains in the temporary storage for some time, so that the first transfer step and the second transfer step are separated in time. Temporarily storing the baggage item in the temporary storage allows for a presorting to take place. While one baggage item is being stored in the temporary storage, other baggage items can be transferred directly from the conveyor belt to the feeder belt. The temporarily stored baggage item can then get onto the feeder belt at a later point in time. This changes the order of baggage items for the loading process. In the embodiment sketched here, the temporary storage is preferably designed in such a way as to be able to hold precisely one baggage item.

In an alternative and likewise preferred embodiment, the transfer unit has several temporary storages, which are designed to hold precisely one baggage item. This makes it possible to further refine a presorting process, since several baggage items can be temporarily stored before getting on the feeder belt. As a result, the order of several baggage items can be easily and efficiently changed, thereby enabling an optimal loading of a freight container. The order realized by the temporary storage can be prescribed or fixed by a control unit. It can preferably depend on the current loading situation of the freight container, as well as on the category of the individual baggage items, their format or other properties.

A likewise preferred embodiment of the baggage sorting facility has a transfer unit which comprises precisely one temporary storage. This temporary storage is preferably designed to be able to hold several baggage items.

The preferred transfer units with a temporary storage are designed in such a way that preferably one respective baggage item can be serviced and processed independently of other baggage items. As a consequence, the baggage items can be transferred to the feeder belt independently of each other.

In preferred embodiments of the baggage sorting facility where the transfer unit comprises a temporary storage, the temporary storage has a baggage rack. This baggage rack serves to receive the baggage from the feeder belt and temporarily store it for a prescribed time or a variable time. The baggage rack is preferably tray-like or tablet-like. It can have a rail-like, net-like or grid-like design. The baggage rack preferably comprises a belt conveyor, a slide or a tilting unit or a robot for transferring the baggage item from the baggage rack onto the feeder belt. In a conceivable exemplary embodiment, the baggage rack is a belt conveyor which moves independently of the conveyor belt and feeder belt when the baggage item is accepted or relayed to the feeder belt. Likewise conceivable is a tablet-like baggage rack, which comprises a tilting unit, so that the baggage item for transfer to the feeder belt can be transferred by tilting the baggage rack.

In a preferred embodiment, the baggage rack of the temporary storage of the transfer unit is designed in such a way that it has essentially the same height as the feeder belt and/or the conveyor belt. The upper side of the baggage rack is thus at the same or essentially the same level as the feeder belt or the conveyor belt. In particular if the baggage rack is designed as a belt conveyor, this type of design is suitable for managing a simple onward transport of the baggage item.

In a preferred embodiment, the transfer unit comprises a control unit, which controls the transfer unit. The control unit causes a baggage item to be transferred from the conveyor belt to the transfer unit, and possibly to a temporary storage, and to be relayed to the feeder belt either at a later point in time or right away. The control unit is preferably designed to control and/or initiate a pickup of the baggage item. In another preferred embodiment, the control unit is designed to additionally or alternatively control and/or initiate the transfer of a baggage item from a temporary storage to the feeder belt.

A likewise preferred embodiment of the baggage sorting facility provides for an automatic baggage item handler, which is designed as a robot, comprises a robot or is part of a robot. The baggage item handler preferably has a gripper, a grabber, a slider, a stamp or a plunger, or is designed as this type of component. The baggage item handler is preferably used to remove a baggage item from the conveyor belt and feed it to the transfer unit, a temporary storage or the feeder belt. It is preferred that several baggage item handlers be present in the transfer unit, in particular in cases where the transfer unit has a temporary storage or several temporary storages.

The baggage sorting facility preferably comprises several baggage item handlers, which can be combined into a transfer unit. Several automatic baggage item handlers are advantageous in cases where the transfer unit has several temporary storages, which can be operated independently of each other. Several baggage item handlers are also advantageous to enable the transfer of baggage items not just into a temporary storage, but also directly from the conveyor belt to the feeder belt.

The automatic baggage item handler is especially preferably designed to move a baggage item essentially perpendicular to the direction of movement of the conveyor belt during removal from the conveyor belt. This arrangement can provide a transfer unit that requires quite a small footprint. In addition, a baggage item can be quickly transferred from the conveyor belt to the transfer unit or the feeder belt.

Likewise preferred is an embodiment of a baggage sorting facility in which the transfer unit is designed essentially flush with the conveyor belt in the area of the transfer unit and free of boundaries between the transfer unit and conveyor belt. This makes it easy to transfer a baggage item from the conveyor belt to the transfer unit or feeder belt. This makes it possible for the baggage items to preferably slide or be pushed from the conveyor belt to the transfer unit, for example if the baggage handler is designed as a plunger or pusher. Barrier-free accessibility between the transfer unit and conveyor belt is preferably present if the transfer unit comprises a temporary storage. A barrier-free accessibility of the same or similar type preferably also exists between the feeder belt and the transfer unit. If the conveyor belt and feeder belt are directly adjacent, no barrier is present between the two belts in a preferred embodiment of the baggage sorting facility, thereby making it easy to push or slide the baggage items over.

In a preferred embodiment of the baggage sorting facility, the baggage detection unit comprises a camera. The camera is preferably a 3D camera or a CCD camera. The camera is preferably arranged in such a way as to be pointed at the transfer unit and/or the conveyor belt, very preferably at the conveyor belt in the area of the transfer unit and/or at the conveyor belt in an area before the transfer unit in the direction of movement. In this way, incoming baggage items can be detected, and the information received in so doing can be processed, so that a transfer decision can preferably be made by the control unit before the baggage item arrives at the transfer point and is processed by the transfer unit.

In a preferred embodiment of the baggage sorting facility, the control unit comprises an input interface, so as to receive information of the baggage detection unit, and select a detected baggage item based on this information. Baggage item detection can here take place in the baggage detection unit, and preferably additionally in the control unit, for example. The control unit is further designed to control the transfer unit or the baggage item handler in such a way that the detected and selected baggage item is transferred from the conveyor belt to the transfer unit. Likewise possible is a control process in which the baggage item is transferred directly from the conveyor belt to the feeder belt, depending on the embodiment of the baggage sorting facility. The information of the baggage detection unit received by the control unit at its input interface preferably comprises a categorization of the detected baggage item. In this way, a reliable decision can be reached about what will happen with the baggage item, i.e., whether the baggage item gets into a temporary storage of the transfer unit or whether it is transferred directly to the feeder belt. Presorting can be improved by using the categorization as information about the baggage item.

The control unit preferably comprises an output interface, at which the generated control signal for the transfer unit or the baggage item handler is output. The control signal is based on information of the baggage detection unit, as well as on additional information, e.g., additional camera images from further cameras or other information, which can be gleaned by reading a barcode or a similar label on a banderole on the baggage item.

In a preferred embodiment of the baggage sorting system according to the invention for an airport, the conveyor belt is a carousel-like belt conveyor or a carousel. Baggage items not removed at the transfer unit can then be transported past the transfer unit repeatedly. In this way, a presorting can likewise take place, even if the baggage sorting facility or its transfer unit have no temporary storage.

In a preferred embodiment of the baggage sorting system, no lateral boundary is provided on the conveyor belt in the area of the transfer unit. At least in the area of the transfer unit, the side of the conveyor belt that faces the transfer unit is free of any such lateral boundary. The conveyor belt is preferably designed in such a way that baggage items are transferred to the transfer unit, or can slide or be pushed over to the latter. This is especially advantageous if the baggage item handler is a plunger, a stamp or a slider or the like, and the baggage items are pushed over.

The invention will be described and explained in more detail below based on a few selected exemplary embodiments in conjunction with the attached drawings:

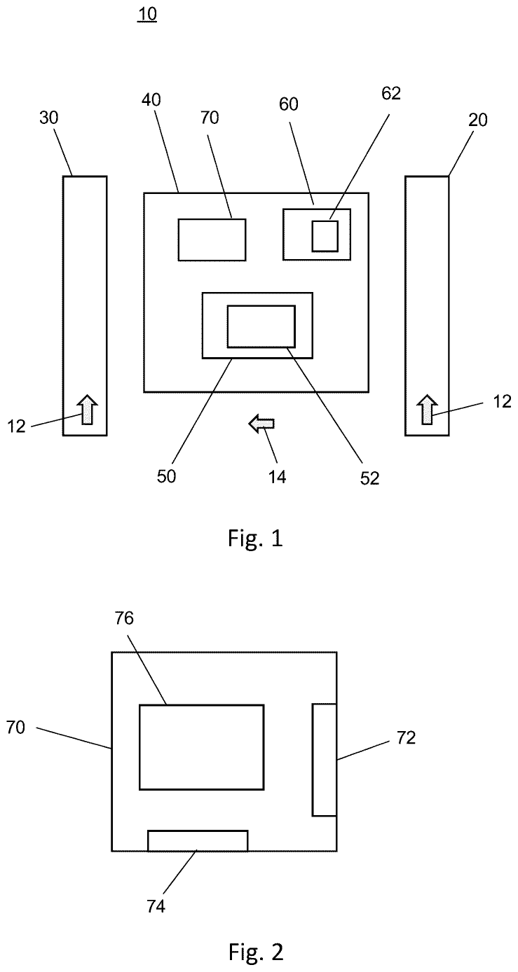

FIG. 1 shows a schematic principle sketch of a baggage sorting system with a baggage sorting facility;

FIG. 2 shows a schematic view of a control unit for a baggage sorting facility;

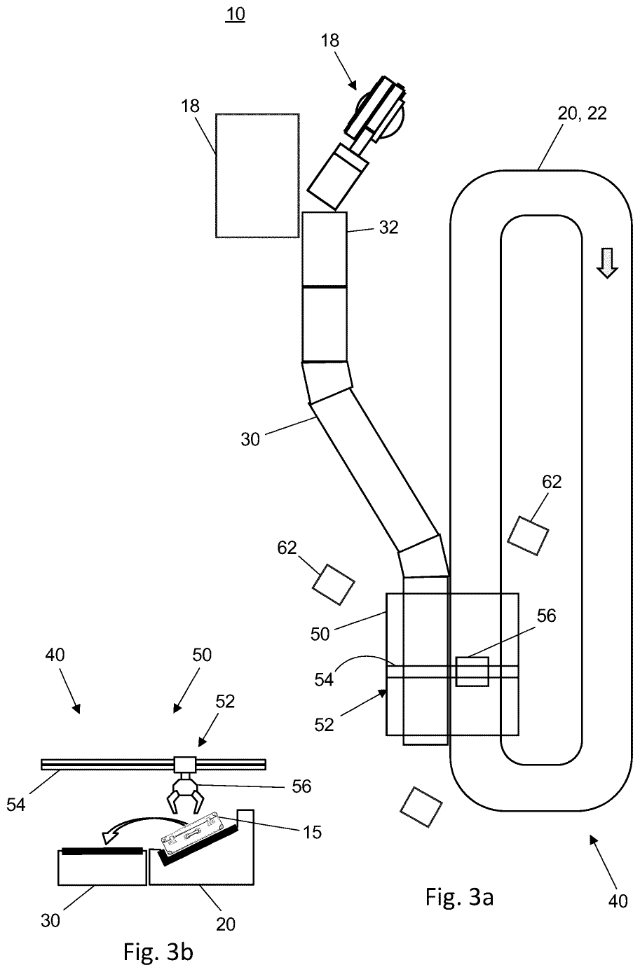

FIGS. 3a, 3b show a baggage sorting system with a transfer unit and a detailed drawing of the transfer unit;

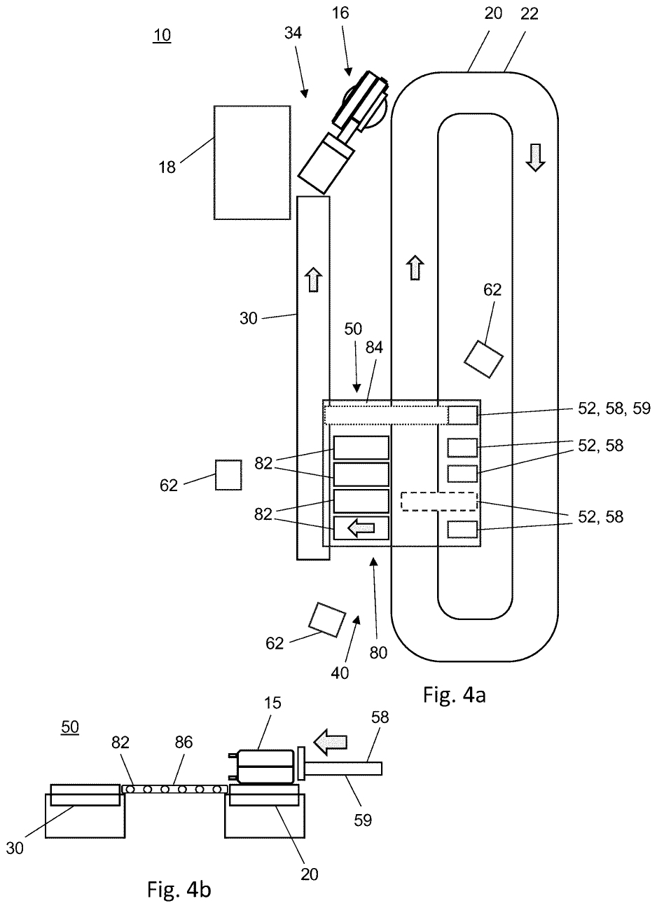

FIGS. 4a, 4b show another embodiment of a baggage sorting system with an alternative transfer unit and a detailed drawing;

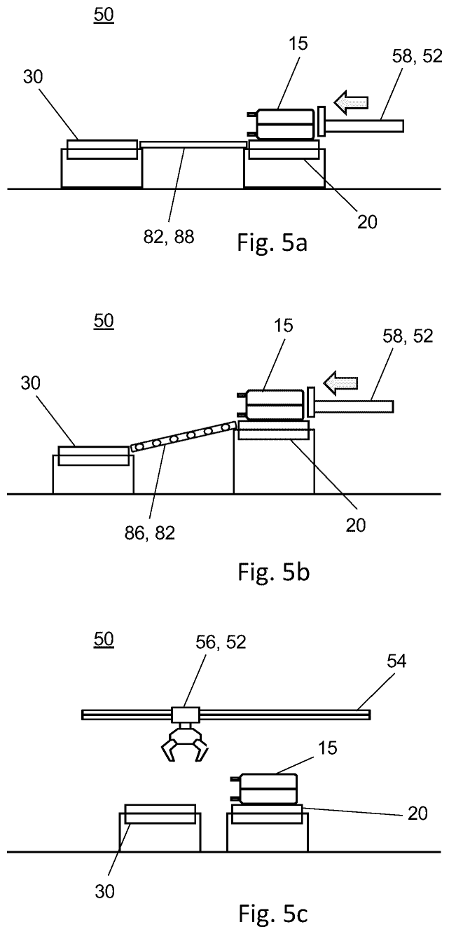

FIGS. 5a-5c show various embodiments of a transfer unit in section; and

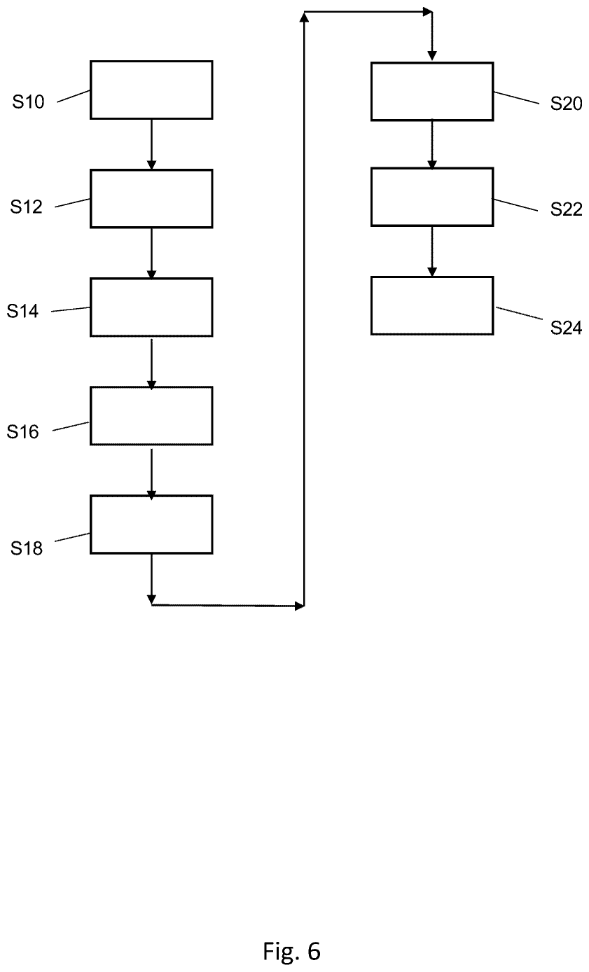

FIG. 6 shows a schematic flowchart of the method according to the invention for automatically presorting and removing baggage items.

FIG. 1 shows an embodiment of a baggage sorting system 10 with a conveyor belt 20 for transporting baggage items within an airport and a feeder belt 30 for feeding baggage items to a loading station, so as to load the baggage items into a freight container. The baggage sorting system 10 further comprises a baggage sorting facility 40, which preferably can be arranged between the conveyor belt 20 and the feeder belt 30. In the embodiment shown here, the respective direction of movement of the conveyor belt 20 and feeder belt 30 is identical, and is denoted by the arrows 12. Of course, the individual bands can move in opposite directions. It is also possible for the conveyor belt 20 and the feeder belt 30 to not be arranged parallel to each other, but rather at any desired angle, and even perpendicular to each other.

The baggage sorting facility 40 is used at an airport for automatically presorting and removing baggage items from the conveyor belt 20 and for transferring the baggage items to a feeder belt 30 adjacent to the conveyor belt 20 to be fed to a loading station (not shown here) for loading a freight container. The baggage sorting facility 40 has a transfer unit 50, a baggage detection unit 60 and a control unit 70.

The transfer unit 50 for transferring baggage items comprises a baggage item handler 52, with which a baggage item is transferred from the conveyor belt 20 to the feeder belt 30. The baggage items are transferred in the direction of the arrow 14. In principle, it is possible for a baggage item to be moved not just perpendicular to the conveying direction or direction of movement (arrow 12) of the conveyor belt 20, but also at an angle that differs from 90°. In practical use, however, it has proven advantageous and expedient that the transfer of baggage items by the conveyor belt and/or feeder belt take place essentially perpendicularly.

The baggage detection unit 60 preferably comprises an optical sensor, very preferably a camera 62, which can, for example, be a 3D camera. High-resolution cameras can also be used, for example to have available a plurality of camera images for evaluation and categorization.

In principle, a categorization can also be based on the shape, size, type and dimensions of a baggage item.

FIG. 2 shows a schematic view of a control unit 70 for selecting individual baggage items for transfer to the feeder belt based on a categorization and/or on predefined requirements or current information for loading into the freight container. The control unit 70 comprises an input interface 72, so as to receive information of the baggage detection unit about baggage items on the conveyor belt. This information can also comprise information about a categorization of the baggage item. Apart from that, additional information or features of the baggage item can be supplied to the control unit 70 via the input interface 72. The input interface 72 is preferably also designed to receive additional information from a placement system for the freight container, such as the current fill status of a freight container, its type, etc.

An output interface 74 of the control unit 70 is designed to output a control signal for the transfer unit or the baggage item handler of the transfer unit. The control signal is used to control the transfer unit in such a way that baggage items are transferred from the conveyor belt to the transfer unit or to the feeder belt.

A processor unit 76 of the control unit 70 is preferably designed to generate the control signal with which the transfer unit is controlled, so as to transport the selected baggage item from the conveyor belt to the transfer unit. The baggage item to be transferred is selected based on the information of the baggage detection unit, the performed categorization and/or additional information.

In principle, the baggage detection unit can also have a two-part or multipart design, wherein one part is directly allocated to the transfer unit. Another part can be arranged at the check-in area or baggage drop-off area of the airport, for example, so that the baggage can be categorized there directly during the baggage drop-off. For example, this can be done manually via an entry by an employee or a passenger. In addition to a categorization during baggage drop-off, another categorization could happen directly in the baggage detection unit near the transfer unit. For example, the categorization can take place based on the images taken by means of a camera.

FIG. 3a shows a schematic view of a baggage sorting system 10 with a baggage sorting facility 40 and a conveyor belt 20 designed as a carousel 22 and a feeder belt 30 directly adjacent to the conveyor belt 20. Arranged at one end 32 of the feeder belt 30 is an automatic placement machine in the form of a robot 16, so as to load baggage items into a freight container 18.

The transfer unit 50 is arranged in the area where the conveyor belt 20 and feeder belt 30 run parallel. A simple transfer from the conveyor belt 20 onto the feeder belt 30 can take place here. In the embodiment shown here, the transfer unit 50 comprises a baggage item handler 52, which is formed by a traverse 54 and a grabber 56.

Several cameras 62 are positioned in proximity to the transfer unit 50, so that baggage items can be observed and recorded both before and during the transfer from the conveyor belt 20 to the feeder belt 30. In this way, the transfer process can be easily and effectively monitored. Enough data in the form of images can be collected to generate sufficient information for a control signal of the control unit. By evaluating the received images, the shape, size and dimensions of a baggage item can be easily determined, as can its category.

In a preferred embodiment, the control unit and/or the baggage detection unit can have an AI unit, so as to detect and/or categorize the baggage items by means of artificial intelligence. Training data can here be recorded from various baggage items and baggage item types and centrally stored in a central computer or memory, in particular to be able to quickly and reliably categorize baggage items.

FIG. 3b shows a section through the transfer unit 50 of the baggage sorting facility 40. The baggage item handler 52 is designed in the form of a grabber 56, which can be moved on a traverse 54 arranged above the conveyor belt 20 and the feeder belt 30. The grabber 56 travels to the desired position, takes a baggage item 15 from the conveyor belt 20 and, after traveling along the traverse 54, places it on the feeder belt 30.

In the embodiment shown here, the feeder belt 30 is horizontally arranged, while the conveyor belt 20 has an inclined position, thereby simplifying the transfer of the baggage item 15 by means of grabbers 56. In addition, the advantage to this embodiment is that the conveyor belt 20, which has the standard design of a carousel 22 with an inclined position as shown here, need not be changed. Adjustments or structural changes are not required.

Since the conveyor belt 20 is designed as a carousel 22 in the embodiment shown here according to FIG. 3a, a sorting or presorting of baggage items 15 can here take place by means of the conveyor belt 20. If an incoming, detected baggage item 5 is regarded as not being ideal for loading into the freight container 18 at the current point in time, the transfer to the feeder belt 30 can be suspended. The baggage item 15 would then continue to be transported on the conveyor belt 20, and arrive at the transfer station 50 again at a later point in time after going around once more. In the meantime, however, other baggage items 15 might have arrived at the transfer unit 50 that appear more suitable. The use of a carousel 22 as the conveyor belt 20 thus offers an easy way to realize a presorting process.

FIG. 4a shows another embodiment of a baggage sorting facility 40 of a baggage sorting system 10. In the embodiment depicted here, the conveyor belt 20 and feeder belt 30 are spaced apart from each other. In any case, the transfer unit 50 is arranged partially between the conveyor belt 20 and feeder belt 30.

The transfer unit 50 comprises several baggage item handlers 52, which can, for example, be designed as pushers 58.

In this preferred embodiment, the transfer unit 50 has a temporary storage 80, which has four transfer locations or baggage racks 82, in which baggage items can be temporarily stored. In this way, the incoming baggage items can be presorted, i.e., the order in which they are fed to the loading station 34 at the end 32 of the feeder belt 30 can be changed.

Also provided apart from the temporary storage 80 comprising the four baggage racks 82 is a direct transfer location 84, at which a direct transfer of the baggage item to the feeder belt 30 takes place. This is the upper transfer location on FIG. 4a, in which the pusher 58 designed as a plunger 59 is extended, as denoted by the dotted line. The transfer unit 50 in the area between the conveyor belt 20 and feeder belt 30 can be designed as a smooth floor or a plate, tablet or tray. This applies in particular to the direct transfer location 84.

FIG. 4b shows a cross section through the transfer unit 50 with conveyor belt 20 and feeder belt 30. The baggage rack 82 in the form of a belt conveyor 86 is arranged between the two belts. A baggage item 15 can thus get from the conveyor belt 20 to the temporary storage 80 by moving the belt conveyor 86, and made to remain there by stopping the belt conveyor 86, i.e., be temporarily stored or stowed. By moving the belt conveyor 86, a baggage item 15 can be transported from the baggage rack 82 to the feeder belt 30 if it was selected for loading into the freight container and the transfer unit 50 was correspondingly controlled. Of course, it is also possible to run the belt conveyor 86 “in reverse”, so that a baggage item could be conveyed back to the conveyor belt 20.

Additional configurations can of course also be realized apart from the embodiment of the transfer unit 50 shown here with four baggage racks 82 in the temporary storage 80. In this way, the number of baggage racks 82 and/or the number of temporary storages 80 can be changed and varied. The more baggage racks available (baggage rack 82), the more precisely a presorting of baggage items 15 and placement in the freight container at the end of the feeder belt 30 can take place.

Of course, transfer units are possible that have no direct transfer location 84, but rather only temporary storages 80 and baggage racks 82.

The temporary storage 80 thus enables a very elegant and effective presorting of the baggage items 15. A transfer of baggage items 15 from the conveyor belt 20 to the feeder belt 30 can take place indirectly if a temporary storage 80 is integrated into the transfer unit 50.

As opposed to the embodiment with several pushers 58 or plungers 59 shown on FIG. 4a, it is also possible to install a pusher 58 on a rail, trolley or traverse, similarly to the grabber 56 on FIG. 3a or 3b. The rail or traverse could preferably be movable in and opposite the transport direction of the feeder belt 30. In this way, several temporary storages 80 or baggage racks 82 could be serviced with only one baggage handler 52.

Instead of a pusher 58 or plunger 59 or a grabber with traverse, a multi-axis robot could alternatively also be positioned near the transfer unit 50, the robot arm of which can move baggage items 15 from the conveyor belt 20 into the temporary storage and then to the feeder belt 30, or directly to the feeder belt 30.

FIGS. 5a-5c show several exemplary embodiments of transfer units 50 with which baggage items 15 can be moved from the conveyor belt 20 to the feeder belt 30; according to FIGS. 5a and 5b, a baggage rack 82 is here interspersed.

The baggage rack 82 is shown as a tablet 88 on FIG. 5a. The pusher 58 can move the baggage item 15 from the conveyor belt 20 to the tablet 88. The baggage item 15 can be further moved from the tablet 88 to the feeder belt 30 either via the same pusher 58 or via a separate or some other baggage item handler 52. It is also possible for the tablet 88 to be tilted, so that a baggage item 15 slides or slips onto the feeder belt 30 in the tilting process. The feeder belt 30 can preferably have a lateral boundary on the side facing away from the tablet 88, so as to prevent a baggage item 15 from sliding down.

While the conveyor belt 20 and feeder belt 30 lie at the same height according to FIG. 5a, the conveyor belt is elevated in relation to the feeder belt 30 according to FIG. 5b. The baggage rack 82 designed as a belt conveyor 86 here enables a continued transport of the baggage item 15 after the latter was moved from the conveyor belt 20 to the baggage rack by means of pushers 58. Continued movement takes place via the belt conveyor 86, so that the baggage item 15 gets to the feeder belt 30. Of course, it is also possible for the feeder belt 30 to be elevated in relation to the conveyor belt 20. The belt conveyor 86 only has to have enough grip or a high enough roughness, so that a baggage item does not slide off the baggage rack 82 on its own.

FIG. 5c shows an embodiment without a temporary storage. The baggage item handler 52 is designed as a grabber 56, which is moved on a traverse 54. The belt conveyor 86 and feeder belt 30 are directly adjacent. The grabber 56 grabs the baggage item 15 and transports it in the direction of the feeder belt 30, and places it there in an additional step, so that it can be moved to the loading station. A (multi-axis) robot could also be used here.

FIG. 6 shows a schematic view of the basic sequence of a method for automatically presorting and removing baggage items from a conveyor belt and for transferring the baggage items to an adjacent feeder belt. This type of method is typically used at an airport when baggage items are to be removed from a conveyor belt and made to arrive at a loading station by means of a feeder belt, so as to enable the loading of a freight container.

In a basic transportation step S10, which is here optional, a baggage item is moved and transported by means of a conveyor belt in the direction of the transfer unit of a baggage sorting facility. This type of step takes place at every airport to transport baggage items from a drop-off point (check-in) to an unloading or loading station.

In an additional step S12, a baggage item on the conveyor belt is detected in proximity to a transfer unit. The transfer unit can be part of a baggage sorting facility. For example, detection can take place by means of a camera, in conjunction with a baggage detection unit.

In a step S14, a known baggage item is categorized according to predefined requirements for loading into the freight container. The predefined requirements can be either based on general specifications and definitions, or determined by the loading station, e.g., based on a current placement situation in a freight container. In this case, for example, categorization could involve a suitability for placement on the freight container, wherein this suitability is temporary and situation dependent. Loading and adding more baggage items into the freight container can cause the suitability and categorization to change accordingly. In this case, a response must take place from the loading station to the baggage detection unit or to a control unit of the baggage sorting facility.

A step S16 involves selecting a baggage item for transfer from the conveyor belt to the transfer unit. The selection can take place based on the categorization and/or the current loading situation and filling situation in the freight container. Additional categorization options include the size, measurements, dimensions, length, width, height or weight ratios of a baggage item.

A step S18 involves transferring the selected baggage item to the transfer unit. In this step, the baggage item can be brought into a position suitable for the transfer.

In a step S20, the baggage item is transferred to the feeder belt. The baggage item can here optionally be temporarily stored in a temporary storage of the transfer unit for a preset or dynamically variable length of time.

In a step S22, the baggage item on the feeder belt is fed to the loading station, e.g., with a baggage item handler provided for this purpose.

The procedural steps described here can be used to presort baggage items in such a way that they arrive at the loading station in a prescribed order. The prescribed order can deviate from the order in which they were transported to the transfer unit on the conveyor.

In an optional and additional step S24, a response can take place from a monitoring unit at the loading station, which can be relayed to the control unit of the baggage sorting facility. This makes it possible to improve the selection and presorting of baggage items, in particular when using artificial intelligence, such as an AI unit, a neuronal network, a Petri network or other computer systems.

The invention was comprehensively described and explained based on the drawings and the specification. The description and explanation are to be understood as exemplary, and not as limiting. The invention is not limited to the disclosed embodiments. Other embodiments or variations arise for the expert during the use of the present invention, as well as during a precise analysis of the drawings, the disclosure and the following claims.

In the claims, the words “comprise” and “with” do not rule out the presence of additional elements or steps. The indefinite article “a” or “an” does not rule out the existence of a plurality. An individual element or an individual unit can perform the functions of several of the units mentioned in the claims. A unit, a facility and a system can be partially or completely implemented in hardware and/or software. The mere mention of several measures in several different dependent claims must not be construed to mean that a combination of these measures cannot likewise be advantageously used. Reference numbers in the claims are not to be understood as limiting.

Reference List

| | |
|---|---|
| 10 | Baggage sorting system |
| 12 | Arrow |
| 14 | Arrow |
| 15 | Baggage item |
| 16 | Robot |
| 18 | Freight container |
| 20 | Conveyor belt |
| 22 | Carousel |
| 30 | Feeder belt |
| 32 | End |
| 34 | Loading station |
| 40 | Baggage sorting facility |
| 50 | Transfer unit |
| 52 | Baggage item handler |
| 54 | Traverse |
| 56 | Grabber |
| 58 | Pusher |
| 59 | Plunger |
| 60 | Baggage detection unit |
| 62 | Camera |
| 70 | Control unit |
| 72 | Input interface |
| 74 | Output interface |
| 76 | Processor unit |
| 80 | Temporary storage |
| 82 | Baggage rack |
| 84 | Direct transfer location |
| 86 | Belt conveyor |
| 88 | Tablet |

1-18. (canceled)

19. A baggage sorting facility for an airport for automatically presorting and removing baggage items from a conveyor belt and transferring the baggage items to a feeder belt adjacent to the conveyor belt for feeding to a loading station for loading a freight container, comprising:
a transfer unit for transferring baggage items from the conveyor belt to the feeder belt;
a baggage detection unit for detecting baggage items and categorizing individual baggage items;
a control unit for selecting individual baggage items for transfer to the feeder belt based on the categorization and/or on predefined requirements for loading into the freight container;
wherein the transfer unit comprises a baggage item handler, which is designed and configured to transfer a baggage item from the conveyor belt to the feeder belt;
wherein the transfer takes place by means of the transfer unit essentially perpendicular to the conveyor belt and/or feeder belt; and
wherein an automatic presorting of baggage items takes place during the transfer.

20. The baggage sorting facility of claim 19, wherein the transfer unit comprises a temporary storage, which is designed to hold a baggage item.

21. The baggage sorting facility of claim 20, wherein the temporary storage is designed to hold precisely one baggage item.

22. The baggage sorting facility of claim 20, wherein the transfer unit comprises several temporary storages, which are designed to hold precisely one baggage item.

23. The baggage sorting facility of claim 20, wherein the transfer unit comprises precisely one temporary storage, which is designed to hold several baggage items.

24. The baggage sorting facility of claim 20, wherein a respective baggage item can be transferred to the feeder belt independently of other baggage items.

25. The baggage sorting facility of claim 20, wherein the temporary storage of the transfer unit comprises a baggage rack.

26. The baggage sorting facility of claim 25, wherein the baggage rack is designed like a tray, tablet, rail, net or grid.

27. The baggage sorting facility of claim 25, wherein the baggage rack comprises a belt conveyor, a slide or a tilting unit, so as to transfer a baggage item to the feeder belt.

28. The baggage sorting facility of claim 25, wherein the baggage rack has essentially the same height as the feeder belt and/or the conveyor belt.

29. The baggage sorting facility of claim 20, wherein the control unit controls the transfer unit, so as to control and/or initiate a pickup of a baggage item.

30. The baggage sorting facility of claim 20, wherein the control unit controls the transfer unit, so as to control and/or initiate the transfer of a baggage item from the temporary storage to the feeder belt.

31. The baggage sorting facility of claim 19, wherein the automatic baggage item handler comprises a robot or is part of a robot.

32. The baggage sorting facility of claim 19, wherein the baggage item handler comprises a gripper, a grabber, a slider, a stamp or a plunger, so as to remove a baggage item from the conveyor belt.

33. The baggage sorting facility of claim 19, wherein the automatic baggage item handler is designed to move a baggage item essentially perpendicular to the direction of movement of the conveyor belt during removal from the conveyor belt.

34. The baggage sorting facility of claim 19, wherein the transfer unit is essentially flush with the conveyor belt in the area of the transfer unit and free of boundaries between the transfer unit and conveyor belt.

35. The baggage sorting facility of claim 34, wherein baggage items can slide or be pushed from the conveyor belt to the transfer unit.

36. The baggage sorting facility of claim 19, wherein the baggage detection unit comprises a camera which is a 3D camera.

37. The baggage sorting facility of claim 36, wherein the camera is pointed at the transfer unit and/or the conveyor belt.

38. The baggage sorting facility of claim 36, wherein the camera is pointed at the conveyor belt in the area of the transfer unit and/or in an area before the transfer unit in the direction of movement of the conveyor belt.

39. The baggage sorting facility of claim 19, wherein the control unit has an input interface for receiving information of the baggage detection unit and selecting a detected baggage item based on the information of the baggage detection unit, and controlling the transfer unit or the baggage item handler in such a way that the selected baggage item is transferred from the conveyor belt to the transfer unit.

40. The baggage sorting facility of claim 39, wherein the information of the baggage detection unit comprises a categorization of the detected baggage item.

41. The baggage sorting facility of claim 19, wherein the control unit comprises an output interface, at which a control signal for the transfer unit or the baggage item handler is output.

42. A baggage sorting system for an airport for automatically presorting and removing baggage items from a conveyor belt and transferring the baggage items to a feeder belt adjacent to the conveyor belt for feeding to a loading station for loading a freight container, comprising:
a baggage sorting facility according to claim 19;
the conveyor belt for transporting baggage items from a drop-off point in the direction toward a loading point at the airport;
the feeder belt for feeding baggage items to a loading station, wherein the loading station is arranged at the end of the feeder belt;
wherein the baggage sorting facility is arranged between the conveyor belt and the feeder belt.

43. The baggage sorting system of claim 42, wherein the conveyor belt is a carousel-like belt or carousel, and the baggage items can be transported past the transfer unit multiple times.

44. The baggage sorting system of claim 42, wherein the conveyor belt in the area of the transfer unit is free of any lateral boundary, at least on a side that faces the transfer unit.

45. The baggage sorting system of claim 44, wherein baggage items can slide or be pushed from the conveyor belt to the transfer unit.

46. A control unit for selecting individual baggage items for transfer to the feeder belt based on a categorization and/or on predefined requirements for loading into the freight container, comprising:
an input interface for receiving information of a baggage detection unit about baggage items on the conveyor belt, wherein the information comprises a categorization of the baggage items;
an output interface for outputting a control signal for a transfer unit or a baggage item handler of the transfer unit, so as to control the transfer unit;
wherein the control unit is designed to select a detected baggage item based on the information of the baggage detection unit and/or the performed categorization; and
wherein the control unit is designed to generate the control signal, with which the transfer unit or the baggage item handler is controlled in such a way that the selected baggage item is transferred from the conveyor belt to the transfer unit.

47. The control unit of claim 46, which is designed to generate a control signal, so as to transfer the selected baggage item from the transfer unit to the feeder belt.

48. A method for automatically presorting and for removing baggage items from a conveyor belt and transferring the baggage items to a feeder belt adjacent to the conveyor belt for feeding to a loading station for loading a freight container at an airport, comprising the following steps:
transporting a baggage item on a conveyor belt;
detecting a baggage item on the conveyor belt in proximity to a transfer unit;
categorizing the detected baggage item;
selecting a baggage item for transfer from the conveyor belt to the transfer unit;
transferring the selected baggage item to the transfer unit;
transferring the baggage item to the feeder belt; and
feeding the baggage item on the feeder belt to the loading station;
wherein a presorting of baggage items takes place in such a way as to feed them to the loading station in a prescribed order.

49. The method of claim 48, wherein categorizing the detected baggage item is performed according to predefined requirements for loading into the freight container.
